(19) United States
(12) Patent Application Publication
(10) Pub. No.: US 2012/0162474 A1
(43) Pub. Date: Jun. 28, 2012

(54) CARD-SHAPED ELECTRONIC DEVICE, COMMUNICATION TERMINAL AND AUTHENTICATION METHOD

(75) Inventor: Hiroshi SUKEGAWA, Tokyo (JP)

(73) Assignee: Kabushiki Kaisha Toshiba, Tokyo (JP)

(21) Appl. No.: 13/234,515

(22) Filed: Sep. 16, 2011

(30) Foreign Application Priority Data
Dec. 22, 2010 (JP) 2010-286543

(51) Int. Cl. H04N 5/228; G06K 9/00

(52) U.S. Cl. 348/231.99; 382/103; 348/E05.031

(57) ABSTRACT

A memory card of an embodiment has an external connection terminal configured to be connected to a card connection terminal of a digital camera having an image pickup unit, a communication unit configured to transmit and receive data wirelessly to and from another digital camera, an image recognition unit configured to extract a characteristic from a recognition image, and a CPU configured to permit subsequent transmission and reception of data to and from the other digital camera when a characteristic of a first recognition image photographed by the image pickup unit and a characteristic of a second recognition image transmitted from the other digital camera correspond to each other.

### CROSS REFERENCE TO RELATED APPLICATION

This application claims the benefit of Japanese Application No. 2010-286543 filed in Japan on Dec. 22, 2010, the contents of which are incorporated herein by this reference.

### FIELD

Embodiments described herein relate generally to a card-shaped electronic device for a host having an image pickup unit to perform communication via a short-distance wireless communication system, a communication terminal configured to have an image pickup unit and perform communication via a short-distance wireless communication system, and an authentication method for performing communication via a short-distance wireless communication system.

### BACKGROUND

Users of digital cameras have a strong need to exchange images which the users picked up with nearby users of other digital cameras after taking photographs. In order to meet the need, a flash memory card has been developed, which contains a communication function for giving a wireless communication function to a digital camera by being inserted into a card slot of the digital camera with no communication function.

The digital cameras with the memory cards containing the communication function inserted into the slots can transmit and receive data to and from each other via a short-distance wireless communication system. In particular, a memory card capable of ad hoc communication in which each terminal itself autonomously performs routing without passing through a base station has high convenience.

Here, in a wireless communication system, another communication terminal that is a communication partner needs to be limited. For example, in a personal computer, communication permission setting is performed by input of a connection address and a password by using a keyboard or the like.

In a digital camera without a keyboard or the like, it is not easy to perform communication permission setting in the conventional method. Therefore, in a known memory card containing a communication function, if a digital camera of a communication partner is fixed in advance, the communication permission setting information is transferred and stored into a memory card via a personal computer or the like.

### BRIEF DESCRIPTION OF THE DRAWINGS

FIG. 1 is an explanatory diagram for explaining a configuration of a memory card, a digital camera, and a short-distance wireless communication system including the digital camera of an embodiment;

FIG. 2 is an explanatory diagram for explaining a configuration of the memory card of an embodiment;

FIG. 3A is an explanatory view for explaining a recognition image of the memory card of an embodiment;

FIG. 3B is an explanatory view for explaining a recognition image of the memory card of an embodiment;

FIG. 3C is an explanatory view for explaining a recognition image of the memory card of an embodiment;

FIG. 3D is an explanatory view for explaining a recognition image of the memory card of an embodiment; and

FIG. 4 is a flowchart for explaining a flow of processing of a memory card of a first embodiment.

### DETAILED DESCRIPTION

### First Embodiment

Hereinafter, a memory card 30 which is a card-shaped electronic device, a digital camera 10 and an authentication method of a first embodiment of the present invention will be described.

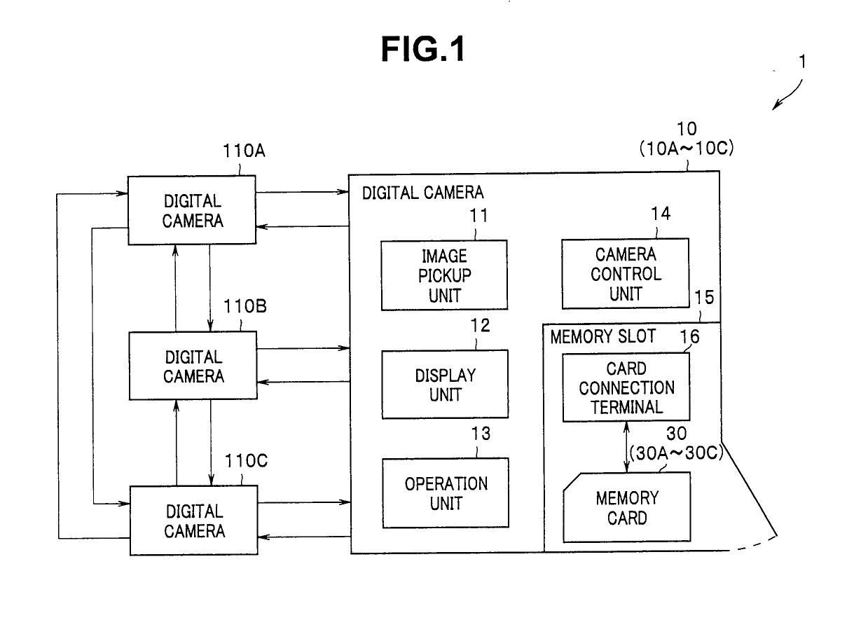

As shown in FIG. 1, the memory card 30 is, for example, an SD memory card (registered trademark) configured to be inserted into a card slot 15 of the digital camera (hereinafter, called “camera”) 10 which is a host and store an image photographed by an image pickup unit 11.

The camera 10 with the memory card 30 inserted in the card slot 15 can configure a short-distance wireless communication system 1 with other digital cameras 110A to 110C which have the same configuration and are present in a short distance. More specifically, the memory card 30 is a memory card containing a wireless communication function.

As shown in FIG. 1, in the short-distance wireless communication system 1, cameras perform ad hoc communication in which the cameras directly perform communication with each other without passing through a base station, an access point or the like.

The camera 10 has the image pickup unit 11, a camera control unit 14, an operation unit 13, a display unit 12 and the card slot 15. The image pickup unit 11 has, for example, a COMS image pickup device or the like and an optical system, photographs an image of a subject, and outputs image data. The operation unit 13 is a shutter button or the like which a user manipulates. The display unit 12 has a liquid crystal panel or the like which displays a through image or a photographed image. The card slot 15 has a card connection terminal 16, and is a housing portion into a camera casing for the memory card 30.

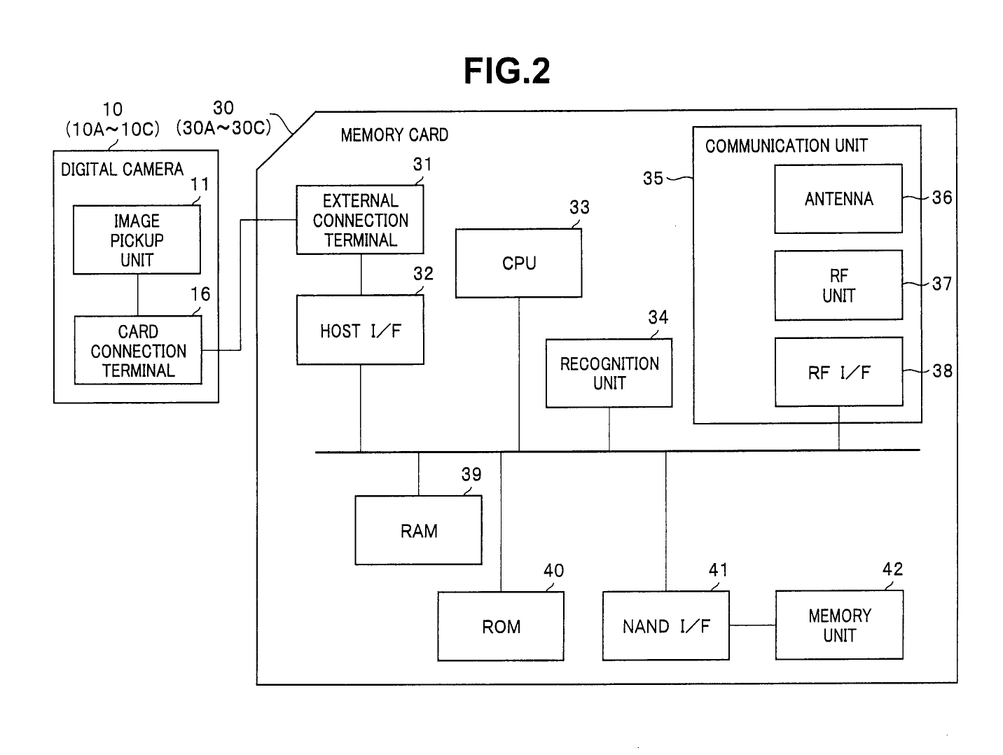

Next, as shown in FIG. 2, the memory card 30 has an external connection terminal 31, a host interface (host IF) 32, a communication unit 35, a recognition unit 34, a CPU 33, a ROM 40, a RAM 39, a NAND interface (memory IF) 41 and a memory unit 42.

The CPU 33 which is a control unit performs control of the entire memory card 30 and at the same time, performs communication control in the communication mode which will be described later, by reading a firmware stored in the ROM 36. The external connection terminal 31 is connected to the card connection terminal 16 when the memory card 30 is inserted/housed in the card slot 15 of the camera 10.

The host IF 32 transmits/receives data to and from the camera 10 and the memory card 30 via the external connection terminal 31. The communication unit 35 has an RF I/F (38), an antenna 36 and an RF unit 37, and performs wireless communication with the digital cameras 110A to 110C which are external communication terminals. The RAM 39 temporarily stores data or the like during an operation. The NAND IF (41) is an interface for performing storage/read of data into and from the memory unit 42. The memory unit 42 includes non-volatile NAND type flash memory cells.

The recognition unit 34 which is an image recognition unit extracts the characteristic from the recognition image as will be described later. For explanation, the recognition unit 34 is set as an independent component, but may be a program which is stored in the ROM 40 or the memory unit 42, and operates by being read by the CPU 33 at the time of operation. The recognition unit 34 as a program which is stored in the memory unit 42 and executed by the CPU 33 can be easily updated.

When the camera 10 is used as an ordinary camera, that is, in an ordinary mode, the user photographs an image of a subject by the image pickup unit 11 by performing a pressing operation of a shutter of the operation unit 13 based on the through image displayed on the display unit 12. The photographed image is transmitted to the memory card 30, and is stored in the memory unit 42 via the host IF 32 and the NAND IF 38. More specifically, in the ordinary mode, the camera 10 and the memory card 30 are operated by control of the camera control unit 14.

The camera 10 is switched into a communication mode by selection of a predetermined operation mode from the control menu of the camera control unit 14. When the camera 10 is switched into the communication mode, the subject which conducts control is changed to the CPU 33 of the memory card 30 from the camera control unit 14. Subsequently, under the control of the CPU 33, data transmission and reception to and from the other cameras 110A to 110C is performed via the short-distance wireless communication system 1. More specifically, the camera 10 does not have a communication function, but becomes capable of short-distance wireless communication by insertion of the memory card 30 into the card slot 15.

The short-distance wireless communication system 1 is, for example, WiFi system which performs transmission and reception of data to and from the cameras within a distance of about several to 100 meters by using radio waves.

In the camera 10 having the memory card 30, communication permission setting for permitting the subsequent transmission and reception of data to and from the camera 110A is performed under the control of the CPU 33 when the characteristic of the first recognition image photographed by the image pickup unit 11 and the characteristic of the second recognition image transmitted from the other camera 110A correspond to each other.

Therefore, the camera 10 can perform transmission and reception of an image to and from not only the cameras for which communication permission setting is performed in advance, but also the camera 110A and the like which can photograph the subject with the same characteristic on site.

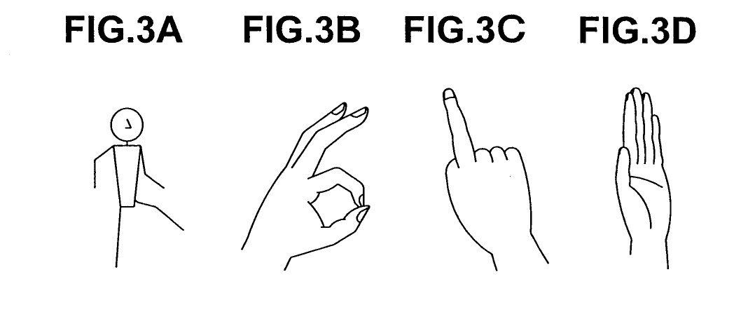

The subject of the recognition image is, for example, a person A present on the site. The characteristic of the image of the person A extracted by the recognition unit 34 can be a characteristic which can be relatively easily extracted. For example, the characteristic may be the color or the pattern of clothing, or may be a posture (pose) or the like using an entire body as shown in FIG. 3A, without being limited to the characteristic of a face.

More specifically, authentication performed by the camera 10 is not strict authentication with high security, but is sufficient for performing grouping with a desired partner from a number of communication partners when a number of communication partners are present within a communication zone.

If the subject of the recognition image is a human hand, the users may photograph their own hands respectively. The hand of the first user photographed by the camera 10 and the hand of the second user photographed by the camera 110A are different. However, the recognition unit 34 discriminates the shapes of the hands in the recognition images as shown in FIGS. 3B to 3D, that is, the shape of the five fingers, and determines that the characters of both of them correspond to each other when the finger signs shown by both of them correspond to each other.

Since the subject of the recognition image is a human body, the memory card 30 realizes a Man-Machine interface which does not need a special preparation/instrument.

When the characteristics extracted from the two recognition images separately photographed by the camera 10 and the camera 110A correspond to each other, the CPU 33 of the camera 10 permits the subsequent communication with the camera 110A.

Subsequently, the camera 10 performs communication only with the camera for which communication permission is set among the cameras within the communicable range of the short-distance wireless communication system 1.

The recognition unit 34 of the memory card 30 does not perform strict determination or the like of whether the same person or not by complicated high-level authentication, but performs authentication for communication permission setting with a relatively easy method.

Since the authentication method of the present embodiment is based on the characteristic of the photographed image, a password with a number of digits or the like does not have to be inputted, and the method can be easily carried out in even the camera 10 which does not have an input unit such as a keyboard.

Further, the subject of the recognition image is arbitrarily decided on site when communication is started. Therefore, a series of authentication operations including selection what to photograph, decision on a pose and the like has entertainingness itself. Therefore, the authentication method of the present embodiment has the effect of enlivening the atmosphere of the scene.

As described above, the camera 10 having the memory card 30 can perform communication permission setting easily and reliably.

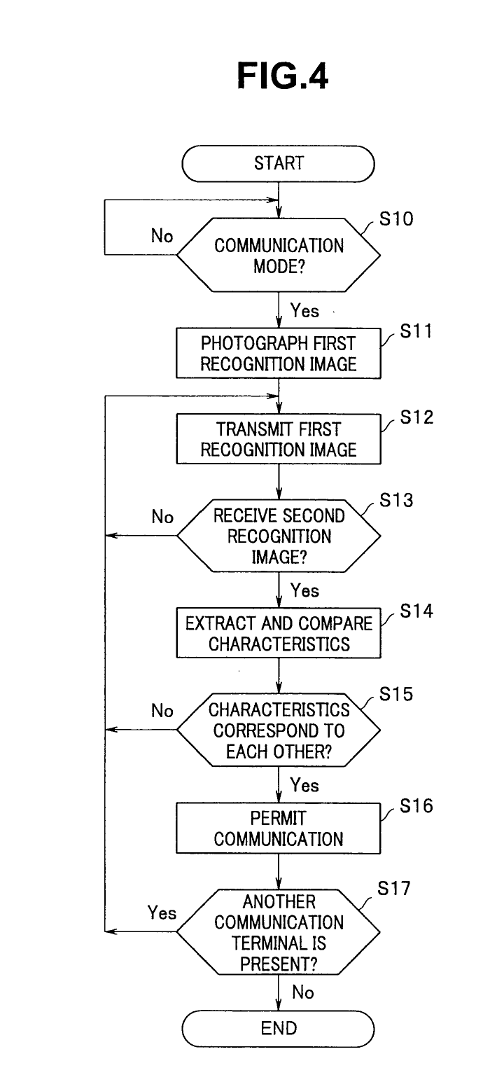

Next, based on the flowchart of FIG. 4, the communication operation of the camera 10 will be described.

### <Step S10> Communication Mode (Memory Card Control) Shifting Step

The camera 10 performs printout setting for printing out, for example, a selected image S from the control menu of the camera control unit 14, and the memory card receives the printout setting and shifts to the communication mode. As a matter of course, the camera control unit 14 may have an exclusive menu for communication mode shifting.

### <Step S11> Recognition Image Acquisition Step

After shift to a communication mode, a predetermined subject, for example, an entire image of a person shown in FIG. 3A is photographed via the image pickup unit 11, and the first recognition image of the person with a left leg raised is acquired.

The users of a plurality of cameras who desire grouping can determine the subject of the recognition image on site by discussion. More specifically, the subject is not determined in advance. Therefore, unlike the conventional recognition method, the recognition method of the embodiment has entertainingness. For example, an unnatural posture can be deliberately requested, or a movement which is not easily reproduced can be requested, from a person to be a subject.

### <Step S12> Recognition Image Transmission Step

The short-distance wireless communication system 1 is an ad hoc network in which the cameras constructing the network perform communication permission setting for each other. More specifically, in order that the other camera 110A and the like communicate with the camera 10, communication permission setting with the camera 10 has to be performed for the camera 110A.

Therefore, the camera 10 transmits the first recognition image via the short-distance wireless communication system 1 for authentication of the other camera 110A.

### <Step S13> Receive Recognition Image?

The CPU 33 detects whether other cameras of the communication target, for example, the cameras which transmit the recognition images are present in the communicable range via the communication unit 35. When a plurality of recognition images can be received, for example, the camera which transmits the signal with the highest radio wave intensity is preferentially selected. On the other hand, when the recognition image is not received (No), the camera 10 repeats the processing from step S12, that is, recognition image transmission.

When the camera 110A of the communication target is present (Yes), the camera 10 receives the second recognition image transmitted from the camera 110A.

The first recognition image and the second recognition image do not have to be the image of the same subject photographed at the same time. For example, even though the camera 10 photographs the person A, and the camera 110A photographs a person B, it is sufficient if only both of them similarly raise left legs, for example. Further, for example, after the camera 10 acquires the image of the person A, the camera 110A may photograph the person B who is taking the same pose while watching the image (first recognition image) displayed on the display unit 12 of the camera 10.

The sequence of the recognition image transmission step and the recognition image reception step may be reverse. That is, after the second recognition image is received, the first recognition image may be transmitted.

### <Step S14> Characteristic Extraction Step

The recognition unit 34 extracts the characteristic of the first recognition image and the characteristic of the second recognition image. For characteristic extraction, a known image recognition technique can be used. The characteristic extraction of the first recognition image may be performed directly after the recognition image acquisition step of step S11, or may be performed only once at the time of contact with the first camera when network connection is performed with a plurality of other cameras.

### <Step S15> Characteristics Correspond to Each Other?

When the characteristic of the first recognition image and the characteristic of the second recognition image correspond to each other (Yes), the processing from step S16 is performed, whereas when they do not correspond to each other (No), the processing from step S12 is performed.

### <Step S16> Communication Permission Step

The CPU 33 permits the subsequent transmission and reception of data to and from the camera 110A. When another communication target camera is present (S17: Yes), the processing from step S12 is repeated.

For example, the camera 110A other than the camera 10 also performs the same operation as that of the camera 10. When the CPU 33 of the camera 10 permits transmission and reception to and from the camera 110A, and the CPU 33 of the camera 110A permits transmission and reception to and from the camera 10, communication between both of them is enabled. The respective cameras repeat the above described operation to perform grouping processing.

Subsequently, the camera 10 transmits an image S selected in the printout mode, and the other cameras which are subjected to grouping receive the image S. By selection of a plurality of images in the printout mode, a plurality of images also can be transmitted. As a matter of course, after the mode is shifted to the communication mode, the image or the like to be transmitted and received may be selected.

As described above, the memory card 30 which is a card-shaped electronic device of the present embodiment facilitates communication permission setting via the short-distance wireless communication system 1 of the camera 10. Further, the memory card 30 having the memory unit 42 which includes nonvolatile NAND memory cells and stores data has higher convenience.

Further, the camera 10 of the present embodiment with the memory card 30 inserted in the card slot 15 is a communication terminal which includes the image pickup unit 11, the communication unit 35 configured to transmit and receive data wirelessly to and from another communication terminal, the recognition unit 34 configured to extract a characteristic from a recognition image, and the CPU 33 configured to permit the subsequent transmission and reception of data to and from the aforesaid other communication terminal when the characteristic of the first recognition image photographed by the image pickup unit 11 and the characteristic of the second recognition image transmitted from the aforesaid other communication terminal correspond to each other.

The communication terminal having the wireless communication function and the authentication function which the memory card 30 has does not need the memory card 30.

More specifically, the short-distance wireless communication device is contained in a camera or a memory card used in a camera, has an image recognition function, performs wireless grouping when input of the same subject is regarded as present in image processing, or when the password/number determined from the subject is coincident, and performs short-distance wireless communication within the group.

Therefore, the camera 10 of the present embodiment can easily perform communication permission setting via the short-distance wireless communication system 1.

Further, the authentication method of the present embodiment includes recognition image acquisition for photographing a subject and acquiring a first recognition image, recognition image transmission for transmitting the first recognition image, recognition image reception for receiving a second recognition image from another communication terminal, characteristic extraction for extracting characteristics of the first recognition image and the second recognition image, and communication permission for permitting subsequent transmission and reception of data to and from the other communication terminal when the characteristics of the first recognition image and the second recognition image correspond to each other.

Therefore, the authentication method of the present embodiment facilitates communication permission setting. Furthermore, the authentication method of the present embodiment has entertainingness.

### Modified Example 1 of the First Embodiment

Next, a memory card 30A, a digital camera 10A and an authentication method (hereinafter, called “memory card 30A and the like”) of a modified example of the first embodiment will be described. Since the memory card 30A and the like of the present modified example are similar to the memory card 30 and the like of the first embodiment, the same components are assigned with the same reference numerals and characters, and the description thereof will be omitted.

Though the memory card 30 and the like transmit and receive a recognition image, the memory card 30A and the like may transmit and receive the characteristic of the recognition image extracted by the recognition unit 34, or may transmit and receive character/number information associated with the characteristic of the recognition image.

For example, when the recognition image is the image of a hand showing a V sign with a forefinger and a middle finger stuck out, the memory card 30A and the like transmit and receive the character information of “V” as the characteristic of the recognition image. The characteristic of the recognition image contains a data amount smaller than that of the recognition image, and therefore, the time required for transmission and reception and the time required for determination whether the characteristics are correspond to each other can be made short.

The memory card 30A and the like have the effect which the memory card 30 and the like have, and further, facilitate communication permission setting.

### Modified Example 2 of the First Embodiment

Hereinafter, a memory card 30B, a digital camera 10B and an authentication method (hereinafter, called “memory card 30B and the like”) of a modified example of the first embodiment will be described. Since the memory card 30B and the like of the present modified example are similar to the memory card 30 and the like of the first embodiment, the same components are assigned with the same reference numerals and characters, and the description thereof will be omitted.

Though the recognition image which the memory card 30 and the like transmit and receive is a static image, the memory card 30B and the like transmits and receives a moving image as a recognition image.

As compared with a static image, a moving image contains a large amount of information. For example, a numeral “2” and a numeral “5” are extracted from a recognition moving image in which a hand with two fingers extended changes into a state with five fingers extended as a hand sign, a two-digit numeral “25” can be set as the characteristic. Further, based on a more complicated gesture, a more unique characteristic can be adopted.

The memory card 30B and the like have the effect that the memory card 30 and the like have, and can reliably identify the communication partner since the memory card 30B and the like perform authentication based on a larger amount of information.

### Second Embodiment

Next, a memory card 30C, a digital camera 10C and an authentication method (hereinafter, called “memory card 30C and the like”) of a second embodiment will be described. Since the memory card 30C and the like of the present embodiment are similar to the memory card 30 and the like of the first embodiment, the same components are assigned with the same reference numerals and characters, and the description thereof will be omitted.

The memory card 30C and the like include a communication setting step of limiting at least any one of the number of other cameras which are permitted to perform transmission and reception, and transmission or reception of data, by the CPU 33 based on the characteristic of the third recognition image photographed by the image pickup unit 11.

More specifically, a camera 10C having the memory card 30C performs photographing/recognition of the third authentication image by the image pickup unit 11 after permitting communication with, for example, one camera 110A, and thereby, the CPU 33 can limit at least any one of the number of other cameras permitted to perform transmission and reception, and transmission or reception of data.

For example, as shown in FIG. 3C, the camera 10C can limit the number of other cameras permitted to perform transmission and reception to one with the image of the hand with one finger extended as the third recognition image photographed by the image pick up unit 11 used as the authentication image.

For example, the camera which transmits a gesture image of beckoning as the recognition image is set at the reception side. Further, for example, by the recognition image with only a thumb extended, the camera can be set to transmit only one image.

More specifically, in the camera 10C, a user can perform a communication operation by using the recognition image photographed by the image pickup unit 11 instead of operating the operation unit or the like of the camera 10.

The camera 10C may perform the recognition image transmission step and the like after the communication setting step by the third recognition image.

The memory card 30C and the like have the effect which the memory card 30 and the like have, and further can easily perform a communication operation other than the authentication step by using the authentication image.

Though the digital camera is described as an example as the communication terminal (host), the communication terminal may be a cellular phone, a PDA or the like if only it is a portable communication terminal having an image pickup unit. Further, the subject of the recognition image may be an article, a landscape or the like. Furthermore, communication permission setting may be performed with combined use of authentication by a voice or the like. Further, the short-distance wireless communication system may be a system via a base station or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A card-shaped electronic device, comprising:
an external connection terminal configured to be connected to a card connection terminal of a host having an image pickup unit;
a communication unit configured to transmit and receive data wirelessly to and from another communication terminal;
an image recognition unit configured to extract a characteristic from a recognition image; and
a control unit configured to permit subsequent transmission and reception of data to and from the other communication terminal when a characteristic of a first recognition image photographed by the image pickup unit and a characteristic of a second recognition image transmitted from the other communication terminal correspond to each other.

2. The card-shaped electronic device according to claim 1,
wherein the control unit limits at least any one of a number of the other communication terminals which are permitted to perform transmission and reception and transmission or reception of data, based on a characteristic of a third recognition image photographed by the image pickup unit.

3. The card-shaped electronic device according to claim 1,
wherein the recognition image is an image of a person.

4. The card-shaped electronic device according to claim 3,
wherein the recognition image is an image of a hand of a person, and the image recognition unit extracts the characteristic from a shape formed of fingers.

5. The card-shaped electronic device according to claim 1,
wherein the recognition image is a moving image.

6. The card-shaped electronic device according to claim 1, further comprising a semiconductor memory unit configured to store data.

7. The card-shaped electronic device according to claim 1,
wherein the host is a digital camera.

8. A communication terminal, comprising:
an image pickup unit;
a communication unit configured to transmit and receive data wirelessly to and from another communication terminal;
an image recognition unit configured to extract a characteristic from a recognition image; and
a control unit configured to permit subsequent transmission and reception of data to and from the other communication terminal when a characteristic of a first recognition image photographed by the image pickup unit and a characteristic of a second recognition image transmitted from the other communication terminal correspond to each other.

9. The communication terminal according to claim 8,
wherein the control unit limits at least any one of a number of the other communication terminals which are permitted to perform transmission and reception and transmission or reception of data, based on a characteristic of a third recognition image photographed by the image pickup unit.

10. The communication terminal according to claim 8,
wherein the recognition image is an image of a person.

11. The communication terminal according to claim 10,
wherein the recognition image is an image of a hand of a person, and the image recognition unit extracts a characteristic from a shape formed of fingers.

12. The communication terminal according to claim 8,
wherein the recognition image is a moving image.

13. The communication terminal according to claim 8,
wherein the communication terminal is a digital camera with a card-shaped electronic device having a wireless communication function inserted in a slot.

14. An authentication method, comprising:
recognition image acquisition for photographing a subject and acquiring a first recognition image;
recognition image transmission for transmitting the first recognition image;
recognition image reception for receiving a second recognition image from another communication terminal;
characteristic extraction for extracting characteristics of the first recognition image and the second recognition image; and
communication permission for permitting subsequent transmission and reception of data to and from the other communication terminal when the characteristics of the first recognition image and the second recognition image correspond to each other.

15. The authentication method according to claim 14, further comprising:
communication setting for photographing a subject and acquiring a third recognition image, and
limiting at least any one of a number of the other communication terminals which are permitted to perform transmission and reception and transmission or reception of data, based on a characteristic of the third recognition image.

16. The authentication method according to claim 15,
wherein the recognition image is an image of a person.

17. The authentication method according to claim 16,
wherein the recognition image is an image of a hand of a person, and a characteristic is extracted from a shape formed of fingers.

18. The authentication method according to claim 14,
wherein the recognition image is a moving image.
